(19) United States
(12) Patent Application Publication
(10) Pub. No.: US 2026/0356048 A1
(43) Pub. Date: Nov. 12, 2026

(54) METHOD AND DEVICE FOR PRODUCING A CONNECTION BETWEEN EXTRUDED SECTIONS

(71) Applicant: Stürtz Maschinenbau GmbH, Neustadt (DE)

(72) Inventor: Jörg Breuer, Burgbrohl (DE)

(21) Appl. No.: 19/130,333

(22) PCT Filed: Nov. 29, 2023
(86) PCT No.: PCT/EP2023/083535

§ 371 Date: May 15, 2025

(30) Foreign Application Priority Data
Nov. 29, 2022 (DE) 10 2022 131 540.1
Jan. 30, 2023 (DE) 10 2023 102 173.7

(51) Int. Cl. B29C 65/20; B29L 31/00

(52) U.S. Cl. CPC B29C 65/20; B29L 2031/006

(57) ABSTRACT

A method and device for producing a connection between two hollow extruded sections made of plastic and/or composite materials, and having visible surfaces and connecting surfaces. The extruded sections that are to be connected to each other are placed with their connecting surfaces against a welding plate that has been heated to a predetermined welding temperature and are pressed thereon, which produces a first length reduction and forms a welding bead composed of the material that is displaced during the length reduction. Before the welding plate is inserted and the extruded sections are pressed against its surface, a locally limited corner region of the connecting surface of at least one extruded section is removed by an associated machining tool by a predetermined amount in relation to the remaining cross-section of the connecting surface that is to be pressed against the welding plate.

### BACKGROUND OF THE INVENTION

### Field of the Invention

The invention relates to a method and device for producing a connection between extruded sections. In particular, the invention relates to a method and device for preparing for and carrying out the welding of two hollow extruded sections made of plastic and/or composite materials and having visible surfaces and connecting surfaces, in which the extruded sections that are to be connected to each other are placed with their connecting surfaces against a welding plate that has been heated to a predetermined welding temperature and are pressed against it, which produces a first length reduction and forms a welding bead composed of the material that is displaced during the length reduction, and after the removal of the welding plate, these extruded sections are joined by means of pressure and with an additional, second length reduction.

### Discussion of Related Art

Such methods are known and are in particular used for producing window frames or window casements from plastic extruded sections, in which in the corner regions of the window frame or window casement, two correspondingly adapted extruded sections are welded to each other at their usually miter-cut connecting surfaces. For this purpose, usually welding devices are used, which, depending on the design of the device, are able to weld together one corner, two corners, or all four corners of a window frame or window casement simultaneously. In this connection, each welding device has a welding head for each corner, with a heatable welding plate as well as a clamping unit for each extruded section. Each clamping unit in this case has an upper and lower limiting ramp between which a respective extruded section is held.

For the actual welding or joining process, the two extruded sections that are to be connected, which are embodied to be approximately 3 mm longer than the dimension of the finished window frame or window casement at their connecting surfaces, are first placed against each other, aligned with each other, and secured in a position in which the two connecting surfaces are spaced far enough apart from each other that the welding plate, usually a heated plate that has been heated to a predetermined temperature, can be inserted between them. Then the connecting surfaces of the two extruded sections are pressed against the welding plate and melted until a first length reduction by, e.g., approximately 2 mm occurs. In this pressing procedure, in all of the regions of the extruded sections that are in contact with the welding plate, a so-called welding bead is produced, which is composed of the material of the extruded section that is displaced during the length reduction. Then the extruded sections are briefly lifted away from the welding plate so that the latter can return to its starting position. Then the heated connecting surfaces of the two extruded sections are once again pressed against each other, as a result of which, with an additional, second length reduction, the above-mentioned welding bead increases in size. The second length reduction occurring here totals about 1 mm and therefore achieves the desired final or finished dimension of the adjacent welded extruded sections, which are connected in the desired way by the welding of the plastic material during the subsequent cooling of the connecting surfaces.

The welding beads or ridges formed by the joining of the extruded sections in the region of the connecting surfaces are present not only all around the outside, but also on all of the partition walls on the inside of the extruded sections. The welding beads can sometimes be sharp-edged and produce an undesirable appearance of the visible surfaces of the resulting window frame or window casement. For this reason, these welding beads are frequently removed in a subsequent step at least on the visible surfaces of the welded and joined window frame or window casement. This is usually carried out by means of special cutters and/or mills on the top or front and on the bottom or back of the welded window frame or window casement, which simultaneously constitute the visible surfaces thereof. The additional work step required for this not only increases the time and effort needed to produce a window frame or window casement, but also requires an additional device. In addition, this generally produces shadow grooves that have a rougher surface that the rest of the surface of the window frame or window casement, which promotes deposits of dirt particles and is difficult to clean.

In order to avoid at least a part of the effort required to remove the visible and thus objectionable welding beads and to thus reduce the time needed to produce a window frame or window casement, it is known from DE 10 2015 013 439 A1 for the outer parts of the welding beads, which are formed on the visible surfaces of the subsequent window frame or window casement in the region of the connecting surfaces in the extruded sections, to be pressed inward after the removal of the welding plate, for the welding plate to then be moved between the connecting surfaces of the extruded sections again, and for the connecting surfaces to be reheated with a simultaneous deformation of the welding beads that have been pressed inward, and finally after the welding plate has been removed once again, for the connecting surfaces of the two extruded sections to be joined to each other. This known method, however, does not produce the desired result for all cross-sections of the extruded sections used for producing window frames or window casements and for all of the plastics used.

DE 10 2017 111 606 A1 also discloses a modified method in which the outer welding bead is also displaced inward before the joining of the extruded sections and is then removed together with the inner beads so that as a result, a kind of shadow groove is produced in the region of the connecting points of the finished window frame or window casement on its visible top or front and on its bottom or back, which is produced by means of a correspondingly contoured cutting blade. Such a shadow groove, however, also has the disadvantage that dirt can easily collect in it, which is difficult to remove, and each cutting blade also produces a roughness on the surface that differs from the rest of the extruded section. If, as is usual in this respect, the extruded sections are provided with a protective film on the visible surfaces before the welding, then at least in the region of the connecting surfaces, this film must be removed before the welding process in order to produce a good weld and a clean cut by the cutting blade, which entails an additional undesirably large amount of effort.

It is known from EP 2 822 751 B1 to produce a step-shaped groove by removing material in the transition region from the connecting surfaces to the visible surfaces before the heating by means of the welding plate and, during the subsequent pressing and welding, to press a pressing die onto the previously produced groove, which is intended to prevent a welding bead from emerging from the visible surface of the welded extruded sections.

It is known from DE 10 2019 109 294 A1 to remove the welding bead in the region of the visible surface of the extruded sections after the removal of the welding plate, forming a step-shaped shoulder in the extruded section at the transition between the visible surface and the connecting surface of the extruded sections, wherein the shoulder is dimensioned such that the material of the extruded sections, which is displaced under pressure in the region of their connecting surfaces during the subsequent joining of the extruded sections, completely fills the step-shaped shoulder between the extruded sections. Thus not only is the weld bead removed in the region of the visible surface, i.e., the front and/or the back of the extruded sections, after the connecting surfaces have come into contact with the welding plate and have been lifted away from it again, but also a step-shaped shoulder is produced in the extruded section in its transition region between the visible surface and the connecting surface, which is dimensioned in such a way that the material that is displaced under pressure then completely fills this step-shaped shoulder between the extruded sections during the joining of the extruded sections in the region of their connecting surfaces. This produces a weld between two extruded sections in which neither a welding bead nor a shadow groove is visible between the extruded sections and instead, they abut each other with an ideally smooth continuation of the visible surfaces.

This method according to the above-mentioned DE 10 2019 109 294 A1 already achieves a significantly improved quality of the profile connection achieved by welding, but certain profile cross-sections cause difficulties, for example in the region of the overlap seal and the profile groove in which the latter is accommodated since in this region there are comparatively large material quantities of both the plastic that is used for producing the extruded section and the sealing profile that is already inserted into the profile groove, which on the one hand can result in a locally more pronounced formation of the welding bead but on the other hand can result in impaired welding in some regions due to the fact that the sealing profile is usually made of a different material than the extruded section itself. These regions cannot be easily machined with the tools used to produce the step-shaped shoulder.

### SUMMARY OF THE INVENTION

The object of the invention is to propose a method and a device of the type mentioned above which overcomes the disadvantages of the prior art.

To attain the stated object, a method is provided in which before the welding plate is inserted and the extruded sections are pressed against its surface, a locally limited corner region of the connecting surface of at least one extruded section is removed by an associated machining tool with a corresponding locally limited working region by a predetermined amount in relation to the remaining cross-section of the connecting surface that is to be pressed against the welding plate.

In this way, the connecting surface of at least one, but preferably both, of the extruded sections that are to be connected is removed in a locally limited way relative to the remaining cross-section of the connecting surface such that when the extruded sections that have been prepared in this way subsequently come into contact with the surface of the welding plate in an intrinsically known way that is described, for example, in DE 10 2019 109 294 A1, in the region of the extruded sections that has been prepared according to the invention, no excess welding bead is produced and melted material does not impair the welded joint that is to be produced.

According to one embodiment of the invention, the locally limited corner of the connecting surface can in particular be constituted by a profile groove provided to accommodate a sealing profile and by the sealing profile that may be positioned therein. The machining tool machines a limited working region that corresponds to the profile groove that accommodates the sealing profile and to the sealing profile that may be positioned therein. It is understood, however, that depending on the profile geometry, the machining according to the invention can also include other corner regions that are critical for the welding.

To prevent the emerging welding bead, as described in DE 10 2019 109 294 A1, the welding bead that has been produced in the region of the visible surface of the extruded sections can be removed after removal of the welding plate by forming a step-shaped shoulder in the extruded profile at the transition between the visible surface and the connecting surface of the extruded sections. The shoulder is dimensioned such that the material of the extruded sections, which is displaced under pressure during the subsequent joining of the extruded sections in the region of their connecting surfaces, completely fills the step-shaped shoulder between the extruded sections. Such a step-shaped shoulder can also be produced in the at least one extruded section before the extruded sections come into contact with the welding plate.

Alternatively, according to embodiments of the invention, in order to prevent the emerging welding bead, after the removal of the welding plate, it is possible for only the outer welding beads produced on the visible surfaces in the region of the visible surfaces of the two extruded sections to be pressed inward to form a beveled edge, and for them to then be removed and for the connecting surfaces of the two extruded sections to then be joined, as is known from DE 10 2017 111 606 A1, whose disclosure content in this regard is incorporated herein by reference.

Other steps can also possibly be taken in order to machine the extruded sections in a material-removing way in the region of the visible surfaces and/or connecting surfaces before or after the extruded sections come into contact with the welding plate so as to prevent the formation of a welding bead that emerges from the visible surfaces during the joining.

The predetermined amount by which the locally limited region is removed is dimensioned so that a welded joint is still produced, but the excess accumulation of material and correspondingly pronounced formation of the welding bead or accumulation of foreign material, e.g., of a sealing profile, are counteracted and according to one proposal of the invention, this predetermined amount totals only 0.5-5 mm. The exact amount depends on the respective profile geometry and can be determined in a simple trial run by the person skilled in the art.

According to one proposal of the invention, the locally limited corner region is removed in a step-shaped way in relation to the visible surface of the extruded section.

Alternatively, instead of forming a step-shaped edge along the removed portion, it is also possible to produce a beveled surface in the locally limited corner region, which is inclined by an angle of, for example, 35 to 65°, and preferably about 45°, in relation to the visible surface of the extruded section. Such a beveled surface makes it possible to achieve a surprisingly significant increase in the achievable strength values of the subsequently executed welding of the extruded sections. In this case, the shape of this beveled surface in the working region that is locally limited to the corner region can be produced, e.g., by means of a multi-pass milling that advances in stages and uses a cylindrical end mill or can also be produced in a single work step directly by means of an adapted milling cutter geometry, i.e., a correspondingly contoured milling cutter.

In addition to end mills, an extremely wide variety of other machining tools such as a saw blade, machining stations that operate with lasers or water jets, etc., are also suitable according to the invention for the locally limited removal of the profile groove accommodating the overlap seal and of the sealing profile that may be positioned therein.

The machining tools are preferably arranged on a machining head, which can be temporarily inserted into the working space (which is also provided for the welding plate) between the extruded sections, which are aligned with each other and clamped in corresponding clamping units. Such a machining head can preferably simultaneously machine both of the extruded sections provided for the connection, for example by supporting a material-removing tool such as an end mill, which is provided for machining an extruded section and is guided in a locally limited way into the corner region of an extruded section that is to be machined. If the machining head has a machining tool in the form of a saw blade, it is also possible to allow the extruded sections, which are usually miter-cut, to temporarily come into contact with each other and to machine them together through a locally limited plunging of the saw blade into the corner region of the extruded sections that comprises the profile groove that accommodates the overlap seal as well as the sealing profile that may be positioned therein. It is also possible to use a milling cutter to machine the extruded sections that are resting against each other.

In addition to clamping and feed devices for two respective extruded sections that are aligned with each other and are to be connected, the device proposed in the context of the invention can also include a heatable welding plate, which can be temporarily inserted into the intermediate space between the extruded sections that are to be connected, as well as material-removing tools associated with the two extruded sections, in order to prevent the formation of a welding bead that emerges from the visible surfaces during the joining, e.g. by producing a step-shaped shoulder at the transition between the visible surface and the connecting surface of the extruded sections before or after the welding in the region of the visible surface of the extruded sections. According to the invention, a machining head is also provided, which in a way comparable to the welding plate, can be temporarily inserted into the intermediate space between the extruded sections that are to be connected in essentially the same position as the welding plate and has at least one machining tool that can be used to remove a locally limited corner region of the connecting surface of at least one extruded section by a predetermined amount in relation to the remaining cross-section of the connecting surface.

For example, the machining tool can be an end mill, a saw blade, or a laser or water jet machining device.

### BRIEF DESCRIPTION OF SEVERAL VIEWS OF THE DRAWINGS

Other embodiments and details of the invention are explained below with reference to exemplary embodiments shown in the drawings. In the drawings:

FIG. 1 shows a view of a device according to the invention that functions in accordance with the method according to the invention;

FIG. 2 shows an extruded section that has been machined in the device according to the invention;

FIG. 3 shows the extruded section according to FIG. 2 in greater detail; and

FIG. 4 shows the machining of the extruded section according to FIG. 2 with a beveled end mill or contoured milling cutter.

### DETAILED DESCRIPTION OF INVENTION

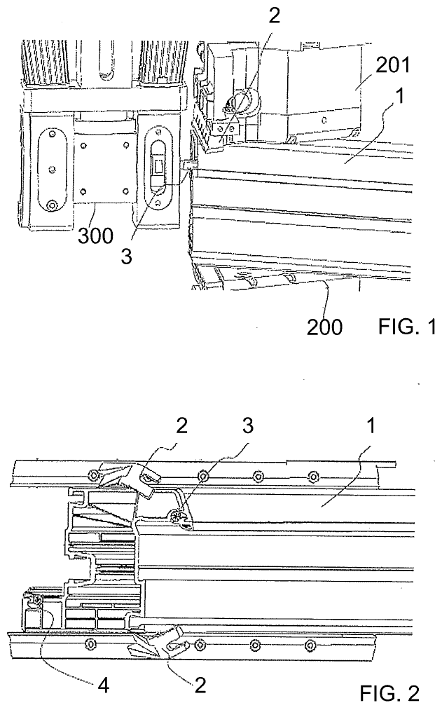

FIG. 1 shows a device, only partially depicted, with which extruded sections 1, in particular hollow plastic extruded sections for producing doors and windows, can be connected in corner sections to form a frame or casement.

A single extruded section 1 to be machined is shown, which is clamped between parts of a clamping device 200, 201. By means of a welding plate that is not shown here the terminal connecting surface of the extruded section 1, which is usually miter-cut, can be welded to another extruded section not shown here by temporarily inserting the heated welding plate into the intermediate space between the extruded sections and pressing the end surfaces of the extruded sections against the surface of the welding plate and melting them. After the end surfaces have been lifted away from the surface of the welding plate again and the welding plate has been removed from the intermediate space between them, a step-shaped shoulder in the extruded sections 1 at the transition between the visible surface and the connecting surface of the extruded sections is removed by a cutting blade 2 in the way described in DE 10 2019 109 294 A1. The shoulder is dimensioned such that the material of the extruded sections that is displaced under pressure in the region of their terminal connecting surfaces during the subsequent joining of the extruded sections completely fills the step-shaped shoulder between the extruded sections.

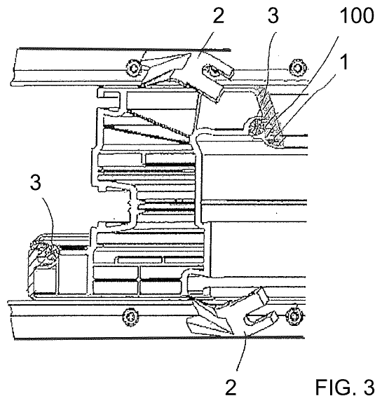

With certain profile cross-sections, such as those shown in FIGS. 2 and 3, difficulties arise in the hatched region 100 shown in FIG. 3, which comprises the profile groove for accommodating the overlap seal and, if applicable, the sealing profile already positioned therein before the connecting of the extruded sections 1 in that a relatively large amount of plastic material of the profile cross-section is present in a locally limited region and, due to the possibly provided sealing profile, a plastic material is also present, which is different from the rest of the plastic material used to form the extruded section 1. This can adversely impact the formation of a weld seam between the extruded sections to be connected that is uniform and is not visible from the outside.

In order to counteract this problem, a machining head 300 is provided, which can be inserted into the intermediate space between the clamped extruded sections 1 as shown in FIG. 1, before the extruded sections 1 are welded. The machining head 300 supports machining tools, in this case end mills 3, which have a locally limited working region that comprises the hatched region 100 of the profile groove shown in FIG. 3, as well as the sealing profile of the overlap seal that may already be positioned therein.

Before the welding plate is inserted, the end mills 3 of the machining head 300 remove this corner region 100 of the profile cross-sections in a locally limited way by a predetermined amount of for example 0.5-5 mm in a step-shaped or right-angled manner so that it is recessed relative to the remaining terminal plane of the connecting surface of the extruded sections 1. The machining head 300 is then removed from the intermediate space and the welding plate can be inserted into the intermediate space in the intrinsically known way in order to heat the terminal ends or connecting surfaces of the extruded sections 1 so that the rest of the process known from DE 10 2019 109 294 A1 can then take place.

Since the region 100 of the extruded sections has been removed in the previous work step, an excessive welding bead is no longer produced in this region during the welding of the extruded sections and the welding bead is also not contaminated by any foreign material of the sealing profile that might adversely affect the weld quality. This significantly improves the quality of the resulting joint.

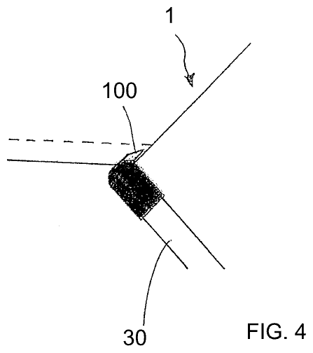

An even better strength of the welded joint is achieved if, instead of a right-angled, step-shaped milled area in region 100, material is removed at an angle of approximately 45° here in relation to the surface of the extruded section 1. This can be achieved either by means of a conventional cylindrical end mill or the like in that the latter passes through the region 100 several times in succession with an increasing advancing motion in order to produce approximately the desired oblique milled edge composed a larger number of small, successive steps, or by means of a correspondingly contoured milling cutter 30 of the kind shown in FIG. 4, which machines the region 100 of the extruded section 1 in a single work step and forms the milled edge that extends at an angle of approximately 45° in this case.

It is understood that instead of end mills 3, 30, other suitable material-removing or non-material-removing tools can be provided, such as saw blades, lasers or water jet cutting devices.

Likewise, the method and device explained above are not limited to the machining of the overlap seal of extruded sections, but can be used on any critical and locally limited regions of the extruded sections to be selected by the person skilled in the art, for example on glazing overlaps, etc.

1. A method for producing a connection between two hollow extruded sections (1) made of plastic and/or composite materials and having visible surfaces and connecting surfaces, the method comprising:
pressing connecting surfaces of the extruded sections (1) against a welding plate that has been heated to a predetermined welding temperature, which produces a first length reduction and forms a welding bead composed of the material that is displaced during the length reduction;
removing the welding plate and joining the extruded sections by means of pressure and with an additional, second length reduction, wherein before or after the extruded sections (1) are placed against the welding plate, the extruded sections are machined with a material-removing process in a region of their visible surfaces and/or connecting surfaces to prevent the formation of a welding bead that emerges from the visible surfaces during the joining;
wherein before the welding plate is inserted and the extruded sections (1) are pressed against its surface, a locally limited corner region (100) of a respective connecting surface of at least one of the extruded sections is removed by an associated machining tool (3) with a corresponding locally limited working region by a predetermined amount in relation to a remaining cross-section of the connecting surface that is to be pressed against the welding plate.

2. The method according to claim 1, wherein the locally limited corner region (100) of the at least one of the extruded sections (1) includes a profile groove provided to accommodate a sealing profile and the associated machining tool (3) machines a working region correspondingly limited to the profile groove to accomodate the sealing profile.

3. The method according to claim 1, further comprising removing the welding bead, to prevent the emerging welding bead after the removal of the welding plate, in the region of the visible surfaces of the extruded sections (1), forming a step-shaped shoulder in the extruded section (1) at a transition between the visible surfaces and the connecting surfaces of the extruded sections (1), wherein the step-shaped shoulder is dimensioned such that the material of the extruded sections (1) that is displaced under pressure during the subsequent joining of the extruded sections (1) fills the step-shaped shoulder between the extruded sections (1).

4. The method according to claim 1, wherein to prevent an emerging welding bead after the removal of the welding plate, only the outer welding beads produced on the visible surfaces in the region of the visible surfaces of the two extruded sections (1) are pressed inward to form a beveled edge and then removed to join the connecting surfaces of the two extruded sections (1).

5. The method according to claim 1, wherein the locally limited corner region (100) is removed by a predetermined amount of 0.5 to 5 mm relative to the remaining cross-section of the connecting surface that is to be pressed against the welding plate.

6. The method according to claim 1, wherein the locally limited corner region (100) is removed in a step-shaped way or by forming a beveled surface extending at an angle of 35 to 65° in relation to the visible surfaces of the extruded sections (1).

7. The method according to claim 1, wherein the locally limited corner region (100) is removed by milling or sawing or by laser or water jet cutting.

8. A device for producing a connection between two hollow extruded sections (1) made of plastic and having visible surfaces and connecting surfaces the device comprising:
clamping devices and feed devices (200, 201) for two respective extruded sections (1) that are aligned with each other and are to be connected;
a heatable welding plate removably insertable into an intermediate space between the extruded sections (1);
material-removing tools configured to prevent an emergence of a welding bead from the visible surfaces during the joining; and
a machining head (300) which, before the welding plate is inserted, is insertable into the intermediate space and supports at least one machining tool (3) configured to remove a locally limited corner region (100) of the connecting surface of at least one extruded section (1) by a predetermined amount in relation to a remaining cross-section of the connecting surface.

9. The device according to claim 8, wherein the locally limited corner region (100) of the extruded section (1) comprises a profile groove provided to accommodate a sealing profile.

10. The device according to claim 8, wherein the machining tool (3) comprises an end mill or milling cutter (30), a saw blade, or a laser or water jet machining device.
